(19) United States
(12) Patent Application Publication
(10) Pub. No.: US 2007/0011473 A1
(43) Pub. Date: Jan. 11, 2007

(54) Method and apparatus of power management for video playback device

(76) Inventor: Chih-Ta Star Sung, Glonn (DE)

Correspondence Address: Chih-Ta Star SUNG;RM. 308, BLD. 52, NO. 195, CHUNG HSING RD., SEC. 4. CHU TUNG TOWNSHIP, HSINCHU COUNTY, 310, TW

(21) Appl. No.: 11/175,353

(22) Filed: Jul. 5, 2005

(51) Int. Cl. G06F 1/00

(52) U.S. Cl. 713/300

(57) ABSTRACT

A power management method of estimating the battery power automatically and entering power saving mode automatically is presented. Power level measuring of the battery and the needed amount of power to run till the end of the selected program is firstly done before a power saving method is selected to reduce the power consumption. Reducing supplier voltage level of the system and component voltage, reducing the bright of the display panel light and reducing sound volume of the speakers are three alternatives of mechanism of power saving.

### BACKGROUND OF THE INVENTION

1. Field of Invention

The present invention relates to method and apparatus of power management of portable video playback device. And more specifically, it automatically reduces the power consumption by measuring the electricity power of a battery, comparing to the required power of a video playback device, and entering the power saving mode.

2. Description of Related Art

Digital video and audio coupled with advantage of sharp image quality of display device make the video playback devices including the TV set, telephony, Video Compact Disc (VCD), DVD, portable media player (PMP) . . . etc become popular in the past decade. The video player can be not only entertainment device but also learning device.

With small size and light weight, the portable video player provides advantage of providing any time and any where entertainment and learning. While, some disadvantage limits the popularity of the portable video player which includes short battery life, small display screen, resolution and not optimized quality of video and audio.

Some portable video players' power line can plug into a power supply when playing video and to charge batter. Most display panels of video players consume high power. Due to high power consumption in display device, playing video without completeness of a selected program is very annoying. Very few portable devices provide functions of measuring and display the level if power left in battery which lets users roughly measure how much time the battery can still last.

This invention of the method and apparatus of the video playback system provides new approach of automatic checking the batter life and the comparing it to the needed power to complete the selected video program and automatic enters the power management mode for power saving and to make the batter last longer time.

### SUMMARY OF THE INVENTION

The present invention is related to method and apparatus of automatic power management specifically for portable video playback device which leads to significant saving of the power consumption and longer battery lifetime between recharging.
The present invention of the method and apparatus of the power management for video playback system automatically enters the power saving mechanism when battery has no enough power to finish playing the video program.
The present invention of the method and apparatus of automatic power management for video playback system measures the power of the battery and the needed power to play the video till the end of the selected program and automatically enters the power saving mechanism if the power can not last till the end of the selected program.
According to an embodiment of the present invention of the of the method and apparatus of automatic power management for video playback system, if the battery power can not last till the end of the selected program, the power saving mode can select options of power saving mechanisms to reduce the power consumption of the video playback device.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of block diagram of a vide playback system with power management which manages the voltage level of the system and components.

FIG. 2 illustrates another prior art of a vide playback system with power management which measuring and indicating the power level of the battery.

FIG. 3 illustrates the procedure of this invention of the power management mode for the video playback system.

FIG. 4 illustrates the block diagram of this invention of a vide playback system with power management which automatically enters the power reduction.

FIG. 5 illustrates the three modes of the power saving of this invention of a vide playback system.

### DESCRIPTION OF THE PREFERRED EMBODIMENTS

Sharp image quality of display device makes the video playback devices including the TV set, telephony, Video Compact Disc (VCD), DVD . . . etc become popular in the past decade. The portable device of video playback system has limit of battery life which if can not supply power to complete playing the whole video program will become very annoying.

The video playback system is comprised of the following main devices which consume most of the total power: display panel (for example, LCD panel), semiconductor components (playback device, LCD controller and driver) and audio speakers. Due to the semiconductor technology migration trend, the power consumption of the semiconductor devices has reduced significantly which helps a lot in reducing the power consumption of the total video playback system. Nevertheless, the power consumption in display device is still high.

Some portable devices of video playback system have implemented an indicator to show the battery power level and let the user roughly measure the time till the end of the video program when the battery runs out of power and stops playing the program.

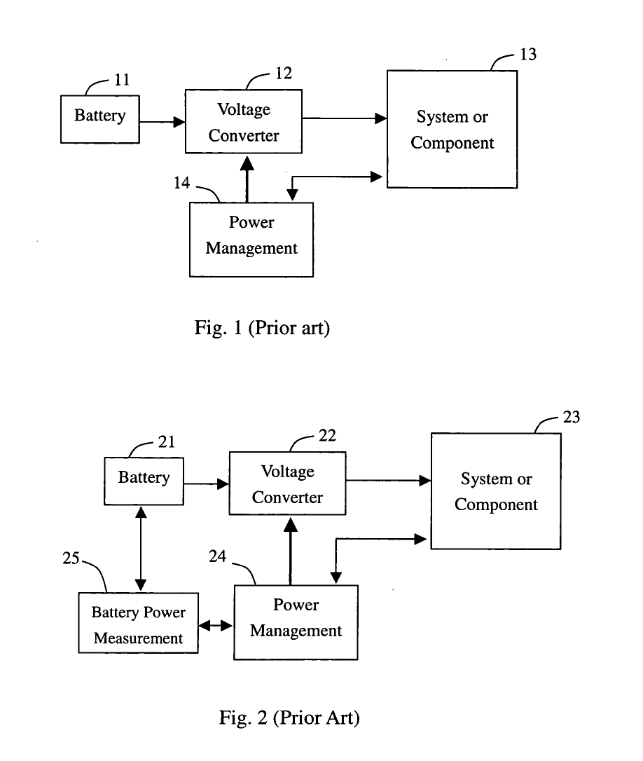

FIG. 1 illustrates the block diagram of a prior art system design which includes a battery 11, a voltage converter unit 12, the system 13 and a power management unit 14. The battery supplies power for the whole system. The voltage converter unit converts the supply voltage level to an approximate level for the system. The power management unit decides the needed voltage level of power supply for the system and refers it to the voltage converter.

FIG. 2 illustrates the block diagram of another prior art system design of video playback system which includes a battery 21, a voltage converter unit 22, the video playback system 23 and a power measurement unit 24 and a battery power level measurement unit 25. The battery supplies power for the whole system. The voltage converter unit converts the supply voltage level to an approximate level for the system. The battery measurement unit measures the level of power in battery and provides information to the power management unit for reference in calculate how much time the batter can last. The power management unit collects the needed amount of power of the system and estimates how much time the battery can support for continuous playing the video program.

Both prior arts shown in FIG. 1 and FIG. 2 can only estimate how much time the battery can support in playing the video program and display the information of time left till end of power. If the user does not take action like plugging the power Cole to a supplier to support the system or to charge the battery, the system will take a final action of shutting down the system.

The present invention of the power management for portable video player overcomes the drawback of prior art designs described in above paragraphs by automatically providing options of mechanisms of power saving.

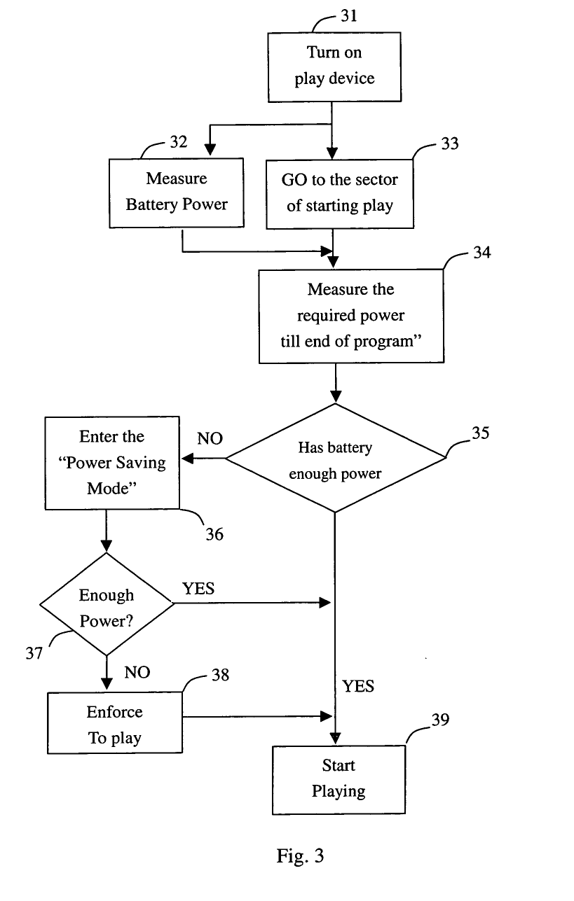

FIG. 3 illustrates the procedure of the present invention of the method and apparatus of power management for portable video player. After turning on the play device 31, the system automatically measure the power left in battery 32. The user selects the starting point 33 of playing the video program. Based on the starting point and the predetermined information of the system specification, the system will measure the amount of required power 34 of running till end of the program, and compare to the amount of power left in battery to decide whether the battery has enough power 35 to support the video player running till the end of the program. If the answer is YES, then, the player can start playing. If NO, then it enters the called “Power Saving Mode” 36 which takes some actions and providing options of reducing the power consumption. And check whether the adjusted mechanism of power saving allows the battery running video till the end of program 37. If the answer is YES, then, the video player can start playing, if NO, the user has option of forcing it to start playing 38 with a risk of stopping before the end of the program.

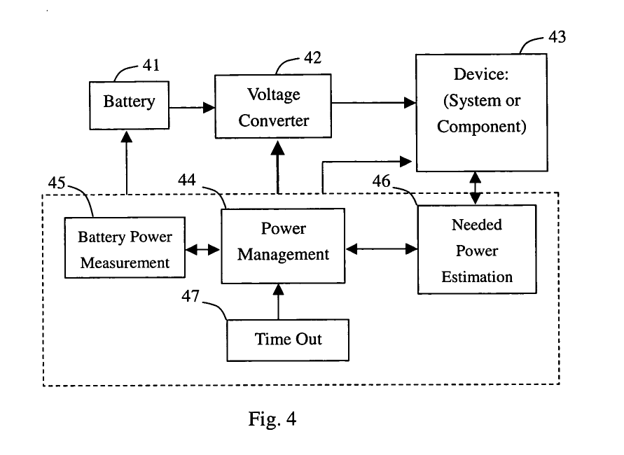

FIG. 4 illustrates the apparatus of the present invention of the power management of the video playing device which is comprised of a battery 41, a voltage converter 42, the video playback system/device 43, a power estimation unit 46, a battery power measurement 45 and the power management unit 44. When power management unit collects all information from the battery power and the estimated needed power amount and determine an appropriate mechanism of power saving. The time out unit 47 including a timer and a register of saving the time out status to inform the power management unit 44 can shut down the system when a predetermined time period is reached with no action of the portable device. Which means if the mobile device has been turned on and left in a non-operating condition for a certain period of time, the time out unit 47 will inform the power management unit to shut down the power.

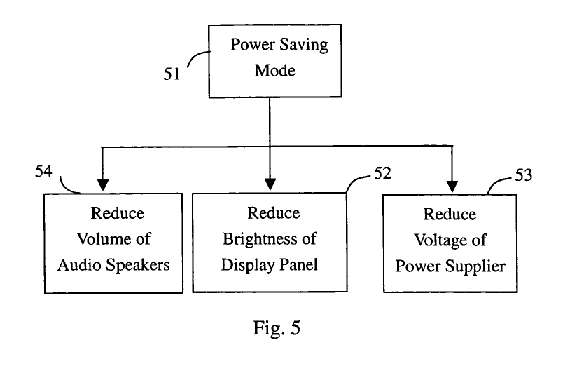

In most video playback system, the display panel dominates around 35% to 50% of the total power consumption. Audio speaker and related DAC and amplifier consumes around 10% power, the rest power is consumed by other components on the system. The present invention reduces power consumption including but not limited to the following three modes as shown in FIG. 5:

Mode 1: Reducing the brightness of the display panel 52

Mode 2: Reducing the voltage level of the power supplier 53

Mode 3: Reducing the sound volume of the audio speaker 54 which includes reducing the current amount of the amplifier.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A power management method of automatically detecting and managing the system power and deciding the method of power saving, comprising:
measuring the level of power left in a battery which stores electronic charge;
measuring how much power the playing device will consume till the end of the selected program; and
entering the power saving mode when the power level in battery can not support to the end of the selected program.

2. The method of claim 1, wherein in deciding the power level needed to run the selected program, the playing device measures the length from the beginning of selected program and end of the program.

3. The method of claim 1, wherein when entering power saving mode, after selecting a mechanism, the playing device calculates the needed power till the end of the selected program and decides whether the battery can support the playing device to run till the end of program.

4. The method of claim 1, wherein when entering power saving mode, if the battery power still can not support playing device to complete playing the selected program, the user can decide whether to force the playing device to start playing.

5. A method of entering power saving mode which helps reducing the power consumption during playing program, comprising
deciding whether the level of power in battery can support running a selected program till the end of program;
entering the power saving mode when the battery power can not support running a selected program till the end; and
selecting at least one alternative of power saving from the predetermined power saving mechanisms.

6. The method of claim 5, wherein if the power of a battery can not support running the selected program till the end of program, before entering power saving mode, the user is informed and provided option to decide whether let the system enter the power management mode;

7. The method of claim 5, wherein when entering power saving mode, power supplier is reduced to an appropriate level which can still support running till the end of the selected program;

8. The method of claim 5, wherein when entering power saving mode, display panel is reduced to an appropriate level of brightness which can still support running till the end of the selected program;

9. The method of claim 5, wherein when entering power saving mode, speaker volume is reduced to an appropriate level which can still support running till the end of the selected program;

10. The method of claim 5, wherein when entering power saving mode, after selecting a method of power saving alternative, if the battery power still can not support of running the program till the end, another power saving alternative will be selected.

11. A method of power saving which helps reducing the power consumption during playing program, comprising
a timer of calculating the length of the time of non-operating status setting a predetermined value of timer; and
informing the power management unit to shut off the power when a predetermined time period of non-operating status is reached.

12. The method of claim 11, wherein a register is implemented to save the status of the time out condition.

13. The method of claim 11, wherein a register saving the status of the time out condition is comprised of a storage device.
